(19) United States
(12) Patent Application Publication
(10) Pub. No.: US 2006/0256488 A1
(43) Pub. Date: Nov. 16, 2006

(54) Medium voltage motor starter including a contactor having motor protection relay functionality

(75) Inventors: Joel E. Benzing, Arden, NC (US); John M. Tillman, Hendersonville, NC (US); Joe M. Kellis, Weaverville, NC (US)

Correspondence Address: MARTIN J. MORAN, ESQ.;Eaton Electrical, Inc., Technology & Quality Center, RIDC Park West, 170 Industry Drive, Pittsburgh, PA, 15275-1032, US

(73) Assignee: EATON CORPORATION

(21) Appl. No.: 11/126,542

(22) Filed: May 11, 2005

(51) Int. Cl. H02H 7/08

(52) U.S. Cl. 361/23

(57) ABSTRACT

A contactor for connecting a medium voltage load, such as a medium voltage three-phase motor, to a medium voltage electrical source, such as a medium voltage three-phase electrical source, and for providing protection functionality for the load includes one or more electrical conductors each having separable contacts such that the load is selectively electrically connected to the source, and one or more current transducers each operatively coupled to a respective one of the electrical conductors for measuring a current thereon. A processor is in electronic communication with the one or more current transducers, and a memory is in electronic communication with the processor. The memory stores one or more routines executable by the processor that are adapted to perform one or more protection functions for the load based on the current measured by each of the one or more current transducers and to selectively open and close the separable contacts of each of said electrical conductors.

### BACKGROUND OF THE INVENTION

1. Field of the Invention

The present invention relates to starters for loads such as electric motors, and more particularly, to a starter for an electric motor having a contactor that provides on-board motor protection relay functionality for protecting the motor from damaging conditions and controlling operation of the motor.

2. Description of the Prior Art

A starter is a device used to provide protection and control for a motor such as three-phase motor and the like typically used in, for example, various industrial settings to operated machinery. A common type of starter includes an electromagnetic contactor and a motor protection relay. The contactor includes separable contacts that are connected to each phase of the electric motor such that, when closed, the separable contacts connect the motor to an electrical source, such as a three-phase electrical source. The motor protection relay monitors the load current and, in some cases, voltage, and trips the contactor open if a problem condition, such as persistent overcurrent, arises. Typically, the motor protection relay tracks an I² t characteristic of the load current, which is a measure of heating. Most current motor protection relays contain a microprocessor which digitally generates the I² t value. When the calculated I² t value reaches a designated trip level, the contactor is tripped open to interrupt the flow of current to the motor.

In prior art starters, the motor protection relay is a discrete device located separately from the contactor and from one or more current transducing and/or voltage transducing elements, which are typically current transformers and voltage transformers, respectively, that measure the currents and voltages being supplied to the motor. The separate motor protection relay is hard-wired to the current transducing and/or voltage transducing elements and to an electromagnetically actuated coil that, under the control of the motor protector relay microprocessor, selectively opens and closes the separable contacts. This additional hard-wiring often makes starter installation and maintenance difficult and time consuming. In addition, many current contactors include a control board having a microprocessor to, for example, control time delays for opening and closing the separable contacts. Thus, many current starters have two separate devices that contain a microprocessor, thereby adding to the expense of the starter. Moreover, current transformers and voltage transformers are bulky, relatively expensive elements, and thus add to the size and cost of starters. Current transformers also have a limited operating range (i.e., the minimum and maximum current levels at which they will operate), and therefore must be matched to the particular motor with which they are to be used. As a result, one constructed, it is often times difficult to use a starter in different applications wherein the motor in question might have different operating characteristics. Thus, there is room for improvement in the field of motor starters.

### SUMMARY OF THE INVENTION

The present invention relates to a starter having a contactor for connecting a medium voltage load, such as a three-phase medium voltage motor, to a medium voltage electrical source, such as a medium voltage, three-phase electrical source, and for providing protection functionality for the load. The contactor includes one or more electrical conductors each having separable contacts such that the load is selectively electrically connected to the electrical source. The contactor also includes one or more current transducers each operatively coupled to a respective one of the electrical conductors for measuring a current thereon. A processor is in electronic communication with the one or more current transducers, and a memory is in electronic communication with the processor. The memory stores one or more routines executable by the processor that are adapted to perform one or more protection functions for the load based on the current measured by each of the one or more current transducers and to selectively open and close the separable contacts of each of said electrical conductors.

In the preferred embodiment, the one or more current transducers each comprise a Rogowski coil. In addition, the contactor further includes one or more voltage transducers, each of which is operatively coupled to a respective one of the one or more electrical conductors for measuring a voltage thereon. The routines in this embodiment are further adapted to perform the one or more protection functions for the load based on one or both of the current measured by each of the one or more current transducers and the voltage measured by each of the one or more voltage transducers. Preferably, the one or more voltage transducers comprise a voltage divider network. The one or more routines may also be further adapted to perform one or more metering functions based on one or both of the current measured by each of the one or more current transducers and the voltage measured by each of the one or more voltage transducers. In addition, the memory may ladder logic, and the routines may be adapted to selectively open and close the separable contacts of each of the electrical conductors based on the one or more protection functions and the ladder logic. Finally, the contactor may include a wireless communications device for transmitting information to or receiving information from a remote device.

### BRIEF DESCRIPTION OF THE DRAWINGS

A full understanding of the invention can be gained from the following description of the preferred embodiments when read in conjunction with the accompanying drawings in which:

FIG. 1 is a block diagram of an electrical motor starter according to the present invention.

### DESCRIPTION OF THE PREFERRED EMBODIMENTS

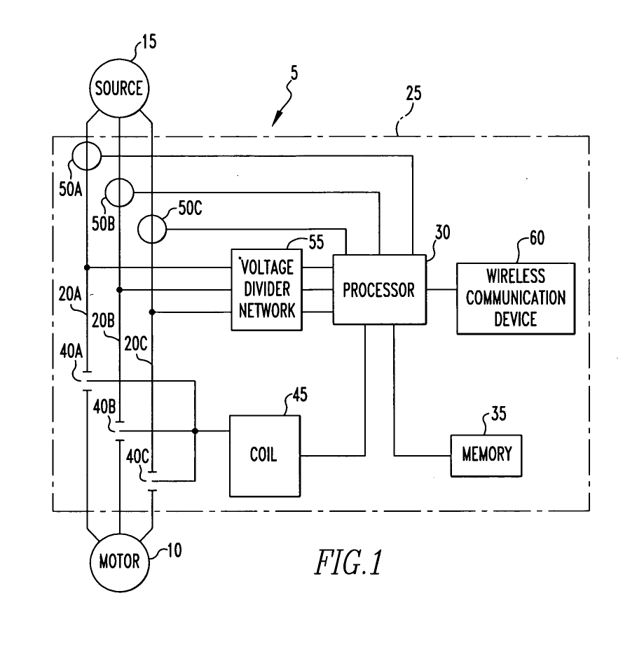

FIG. 1 is a block diagram of a starter 5 according to the present invention. Starter 5 controls the energizing of a medium voltage motor 10, which in this embodiment is a three phase motor, by a three-phase medium voltage electrical source 15 having electrical conductors 20A, 20B and 20C. As used herein, medium voltage shall refer to an operating range of between approximately 2,300 volts and approximately 15,000 volts. A narrow, preferred operating range is a range of between approximately 2300 volts and approximately 7,200 volts. Starter 5 includes contactor 25 according to an aspect of the present invention which connects motor 10 to electrical source 15 and provides protection for the motor 10. Contactor 25 includes processor 30, which may be a microprocessor such as a microcontroller. Processor 30 is in electronic communication with memory 35. Memory 35 may be any of a variety of internal an/or external storage media including RAM, ROM, EPROM, EEPROM, and/or the like, alone or in combination. Memory 35 stores one or more routines executable by processor 30 for the processing of data. The routines can be in any of a variety of forms such as, without limitation, software, firmware, and the like, and may include one or more subroutines, processes, procedures, function calls or the like, alone or in combination. Contactor 25 also includes separable contacts 40A, 40B, and 40C located in electrical conductors 20A, 20B and 20C, respectively. Separable contacts 40A, 40B, and 40C are each operatively coupled to an electromagnetic coil 45 which, when energized under the control of processor 30, selectively opens and closes separable contacts 40A, 40B, and 40C.

Contactor 25 further includes current transducers 50A, 50B and 50C for measuring the current on each electrical conductor 20A, 20B and 20C, respectively. Each of the current transducers 50A, 50B and 50C is in electronic communication with processor 30 for providing current data thereto. In the preferred embodiment of starter 5 shown in FIG. 1, current transducers 50A, 50B and 50C each comprise a Rogowski coil, although other types of current transducing elements may also be used. As is known in the art, a Rogowski coil is a closed toroidal coil on a non-magnetic core, such as a plastic molding, that is placed around a conductor. The magnetic field generated by the alternating current in the conductor induces a voltage in the Rogowski coil that is directly proportional to the current in the conductor. Rogowski coils are advantageous because they are relatively small in size, have a wide operating range, and generate low current signals that may safely be fed to processor 30. Contactor 25 also preferably includes one or more voltage transducers for measuring the voltage on each electrical conductor 20A, 20B and 20C. In the preferred embodiment, shown in FIG. 1, the voltage transducing functionality is provided by three-phase resistive voltage divider network 55 that is in electronic communication with processor 30 for providing the measured voltage data thereto. Like Rogowski coils, known resistive voltage divider networks like resistive voltage divider network 55 are relatively small and relatively inexpensive to implement.

According to an aspect of the present invention, memory 35 is provided with routines executable by processor 30 for providing various current and voltage based motor protective functions (based on the current and voltage data that is sent to processor 30), including, without limitation, the following known ANSI defined (per ANSI/IEEE C37.2) relay functions: 49/51 Overload I²T, 49S/51 Locked Rotor, 51R Jam/Stall, 37 Loss of Load/Underload, 46 Phase Loss/Unbalance, 50 Phase Instantaneous OC, 50G Ground Inst. OC, and 66 Starts per time period. As discussed above, such functions were, in the prior art, performed by the microprocessor of the separate motor protection relay. Memory 35 is also preferably provided with routines executable by processor 30 for performing various known current, voltage and metering functions, such as power factor calculation and the like. Finally, memory 35 is also preferably provided with routines executable by processor 30 for controlling the opening and closing of separable contacts 40A, 40B, and 40C (through coil 45) based on the motor protection functions as well as internally programmed ladder logic. As is known in the art, ladder logic is a programming method for creating electrical logic schematics that is used widely in industrial programmable logic controller applications, wherein a series of complex logic checks, perhaps based on external inputs, are required before a signal is issued.

According to a further aspect of the present invention, contactor 25 is provided with a wireless communications device 60, such as a wireless transceiver or the like, that is in electronic communication with processor 30. Wireless communications device 60 may be used to wirelessly transmit information, such as measured and/or calculated current, voltage or power information or information relating the function of starter 5, from contactor 25 to a remote device such as, without limitation, an operator interface panel, remotely located I/O blocks or terminals, or remotely located RTD modules (measure temperature in the motor windings) using a known wireless communications protocol such as the Bluetooth or ZigBee RF protocols. Alternatively, such information may be transmitted to such remote devices using a wired connection, such as a twisted pair or fiber optic connection.

Thus, the present invention provides a starter having complete motor protection functionality that is implemented in a single discrete device, i.e., the contactor, thereby reducing the cost of the starter and simplifying the installation and maintenance of the starter. In addition, in one aspect, the present invention utilizes components such as Rogowski coils and voltage divider networks that help to reduce the size and cost of the starter, and, by replacing current transformers, allow the same starter to be used in a number of different motor applications having different operating ranges.

While specific embodiments of the invention have been described in detail, it will be appreciated by those skilled in the art of various modifications and alternatives to those details could be developed in light of the overall teachings of the disclosure. For example, the various embodiments described herein have been described in connection with a motor. However, the starter described herein may also be used to protect and control other types of loads such as, without limitation, power transformers and capacitors. Accordingly, the particular arrangements disclosed are meant to be illustrative only and not limiting as to the scope of the invention which is to be given the full breadth of the claims appended and any and all equivalents thereof.

What is claimed is:

1. A contactor for connecting a medium voltage load to a medium voltage electrical source and for providing protection functionality for the load, comprising:
one or more electrical conductors, each of said electrical conductors having separable contacts, said load being selectively electrically connected to said electrical source by said one or more electrical conductors;
one or more current transducers, each of said current transducers being operatively coupled to a respective one of said one or more electrical conductors for measuring a current thereon;
a processor in electronic communication with said one or more current transducers; and
a memory in electronic communication with said processor, said memory storing one or more routines executable by said processor, said one or more routines being adapted to perform one or more protection functions for said load based on the current measured by each of said one or more current transducers and to selectively open and close the separable contacts of each of said electrical conductors.

2. The contactor according to claim 1, wherein said one or more current transducers each comprise a Rogowski coil.

3. The contactor according to claim 1, wherein said load comprises a medium voltage motor.

4. The contactor according to claim 1, wherein said electrical source comprises a medium voltage three-phase electrical source and wherein said one or more electrical conductors comprise first, second and third electrical conductors.

5. The contactor according to claim 4, wherein said load comprises a medium voltage three-phase motor.

6. The contactor according to claim 1, wherein a wireless communications device is in electronic communication with said processor for transmitting information to or receiving information from a remote device.

7. The contactor according to claim 1, wherein said memory includes ladder logic, and wherein said routines are adapted to selectively open and close the separable contacts of each of said electrical conductors based on said one or more protection functions and said ladder logic.

8. A contactor for connecting a medium voltage load to a medium voltage electrical source and for providing protection functionality for the load, comprising:
one or more electrical conductors, each of said electrical conductors having separable contacts, said load being selectively electrically connected to said electrical source by said one or more electrical conductors;
one or more current transducers, each of said current transducers being operatively coupled to a respective one of said one or more electrical conductors for measuring a current thereon;
one or more voltage transducers, each of said voltage transducers being operatively coupled to a respective one of said one or more electrical conductors for measuring a voltage thereon;
a processor in electronic communication with said one or more current transducers; and
a memory in electronic communication with said processor, said memory storing one or more routines executable by said processor, said one or more routines being adapted to perform one or more protection functions for said load based on one or both of the current measured by each of said one or more current transducers and the voltage measured by each of said one or more voltage transducers and to selectively open and close the separable contacts of each of said electrical conductors.

9. The contactor according to claim 8, wherein said one or more voltage transducers comprise a voltage divider network.

10. The contactor according to claim 8, wherein said one or more current transducers each comprise a Rogowski coil.

11. The contactor according to claim 9, wherein said one or more current transducers each comprise a Rogowski coil.

12. The contactor according to claim 8, wherein said load comprises a medium voltage motor.

13. The contactor according to claim 8, wherein said electrical source comprises a medium voltage three-phase electrical source and wherein said one or more electrical conductors comprise first, second and third electrical conductors.

14. The contactor according to claim 13, wherein said load comprises a medium voltage three-phase motor.

15. The contactor according to claim 8, wherein a wireless communications device is in electronic communication with said processor for transmitting information to or receiving information from a remote device.

16. The contactor according to claim 8, wherein said one or more routines are further adapted to perform one or more metering functions based on one or both of the current measured by each of said one or more current transducers and the voltage measured by each of said one or more voltage transducers.

17. The contactor according to claim 8, wherein said memory includes ladder logic, and wherein said routines are adapted to selectively open and close the separable contacts of each of said electrical conductors based on said one or more protection functions and said ladder logic.
